(19) United States
(12) Patent Application Publication
(10) Pub. No.: US 2025/0162659 A1
(43) Pub. Date: May 22, 2025

(54) FRONT LOWER STRUCTURE OF VEHICLE BODY

(71) Applicants: Hyundai Motor Company, Seoul (KR); Kia Corporation, Seoul (KR)

(72) Inventor: Songjae Jeong, Hwaseong-si (KR)

(21) Appl. No.: 18/919,693

(22) Filed: Oct. 18, 2024

(30) Foreign Application Priority Data
Nov. 21, 2023 (KR) 10-2023-0162370

(51) Int. Cl. B62D 25/20

(52) U.S. Cl. CPC B62D 25/2045

(57) ABSTRACT

An embodiment front lower structure of a vehicle body includes a front side inner member disposed along a front-to-back direction of the vehicle body on a front lower part of the vehicle body, an upper joint member connected to a rear upper part of the front side inner member and disposed along the front-to-back direction of the vehicle body, and a lower joint member connected to a rear lower part of the front side inner member and a lower part of the upper joint member and disposed along the front-to-back direction of the vehicle body.

### CROSS-REFERENCE TO RELATED APPLICATIONS

This application claims the benefit of Korean Patent Application No. 10-2023-0162370, filed on Nov. 21, 2023, which application is hereby incorporated herein by reference.

### TECHNICAL FIELD

The present invention relates to a front lower vehicle body structure.

### BACKGROUND

Recently, vehicles with a short front overhang design have become popular.

Front overhang refers to the distance between the front of the vehicle and the wheel base.

A short front overhang vehicle can achieve a sleek and dynamic design and can improve driving performance by bringing the end of the vehicle body closer to the center of the vehicle. Additionally, short front overhang vehicles have the advantage of being able to drive smoothly even in narrow alleys by reducing the minimum turning radius.

Additionally, as the trend has recently shifted from internal combustion engine vehicles to electric vehicles, collision absorption space tends to decrease. In other words, the use of high voltage batteries is increasing to improve the travel distance of electric vehicles (EVs), and the entire weight of the vehicle is increasing due to the installation of high voltage batteries.

In other words, there is a risk of injury to occupants due to a decrease in collision absorption space, and there is a possibility of fracture of the side member and dash surface due to an increase in vehicle weight.

The matters described in this background section have been prepared to improve understanding of the background of embodiments of the invention and may include matters that are not already known prior art.

### SUMMARY

The present invention relates to a front lower vehicle body structure. Particular embodiments relate to a front lower vehicle body structure that reduces injuries to occupants in the event of a vehicle collision.

Embodiments of the present disclosure provide a front lower structure of a vehicle body with a stable structure that reduces the possibility of a side member and dash surface fractures.

Additionally, embodiments of the present disclosure provide a front lower vehicle body structure with a restraint energy (RTE) reduction structure to reduce injuries to occupants.

A front lower structure of a vehicle body according to an embodiment may include a front side inner member disposed along the front-to-back direction of the vehicle body on a front lower part of the vehicle body, an upper joint member connected to a rear upper part of the front side inner member and disposed along the front-to-back direction of the vehicle body, and a lower joint member connected to a rear lower part of the front side inner member and a lower part of the upper joint member and disposed along the front-to-back direction of the vehicle body.

The front lower structure may further include a rear lower member connected to the upper joint member and the lower joint member and mounted on rear parts of the upper joint member and the lower joint member.

The front lower structure may further include a front side outer member connected to the front side inner member, the upper joint member, the lower joint member, and the rear lower member, and the front side outer member may be mounted in an outside direction of the vehicle body.

The front side inner member may include a front side upper surface, a front side inner surface curved from the front side upper surface, a front side lower surface curved from the front side inner surface, and a front side upper flange and a front side lower flange that are respectively curved from the front side upper surface and the front side lower surface and connected to the front side outer member.

The upper joint member may include an upper joint upper surface connected to the front side upper surface, an upper joint upper flange curved from the upper joint upper surface, an upper joint inner surface connected to at least a portion of the front side inner surface, and an upper joint inner flange curved from the upper joint inner surface.

The lower joint member may include a lower joint lower surface connected to the front side lower surface, a lower joint lower flange curved from the lower joint lower surface, a lower joint inner surface connected to at least a portion of the front side inner surface, and a lower joint inner flange curved from the lower joint inner surface.

The upper joint member and the lower joint member may further include an upper joint front connecting portion and a lower joint front connecting portion connected to the rear of the front side inner member, respectively.

A front of the rear lower member may be connected to the rear of the front side inner member.

The upper joint member and the lower joint member may be connected to form a joint space on the inside, and a part of the rear lower member may be connected to the inside of the joint space.

The front lower structure may further include a dash panel connected to the rear of the upper joint member, an upper portion of the rear lower member, and a rear of the front side outer member.

The upper joint member may include an upper joint rear flange curved to be connected to the dash panel.

The upper joint rear flange may include an upper joint rear upper flange curved from the upper joint upper surface formed at the upper portion thereof and an upper joint rear inner flange curved from the upper joint inner surface formed on an inner side thereof.

The rear lower member may include a rear lower member body of a “U” shaped cross-section shape and a rear lower member flange that is curved from the rear lower member body and connected to the dash panel.

The lower joint member may include a lower joint inner flange connected to the dash panel through the rear lower member flange.

According to an embodiment of the front lower structure of a vehicle body, the connection between the side member and the dash surface can be strengthened, the connection between the side member and the rear lower member can be reinforced, and the flange can be connected in three directions to prevent separation.

In addition, according to an embodiment of the front lower structure of a vehicle body, collision energy can be stably distributed to the dash and the floor, and ride down energy (RDE) can be increased through joint deformation, thereby reducing the RTE.

In addition, the effects that can be obtained or predicted from an exemplary embodiment will be disclosed directly or implicitly in the detailed description of the embodiments of the present invention. That is, various effects expected according to embodiments of the present invention will be disclosed in the detailed description to be described later.

### BRIEF DESCRIPTION OF THE DRAWINGS

Since these drawings are intended for reference in explaining exemplary embodiments of the present invention, the technical ideas of the present invention should not be interpreted as being limited to the accompanying drawings.

FIG. 1 is a perspective view from the bottom of a front lower structure of a vehicle body according to an embodiment.

FIG. 2 is a drawing with a lower joint member excluded in FIG. 1.

FIG. 3 is a drawing with a front side inner member excluded in FIG. 2.

FIG. 4 is a drawing with a rear lower member excluded in FIG. 3.

FIG. 5 is a perspective view of the front side inner member of the front lower structure of a vehicle body according to an embodiment.

FIG. 6 is a perspective view of an upper joint member of the front lower structure of a vehicle body according to an embodiment.

FIG. 7 is a perspective view of the lower joint member of the front lower structure of a vehicle body according to an embodiment.

FIG. 8 is a perspective view of the rear lower member of the front lower structure of a vehicle body according to an embodiment.

FIG. 9 is a cross-sectional view along line A-A in FIG. 1.

FIG. 10 is a cross-sectional view along line B-B in FIG. 1.

FIG. 11 is a cross-sectional view along line C-C in FIG. 1.

FIG. 12 is a drawing showing load transfer paths of the front lower structure of a vehicle body according to an embodiment.

The following reference identifiers may be used in connection with the drawings to describe various features of embodiments of the present invention.

| | |
|---|---|
| 1: front lower structure of a vehicle body | 10: front side inner member |
| 12: front side upper surface | 14: front side inner surface |
| 16: front side lower surface | 18: front side upper flange |
| 20: front side lower flange | 30: upper joint member |
| 32: upper joint upper surface | 34: upper joint upper flange |
| 36: upper joint inner surface | 38: upper joint inner flange |
| 40: upper joint front connecting portion | 42: upper joint rear flange |
| 44: upper joint rear upper flange | 46: upper joint rear inner |
| | flange |
| 45: joint space | 50: lower joint member |
| 52: lower joint lower surface | 54: lower joint lower flange |
| 56: lower joint inner surface | 58: lower joint inner flange |
| 60: lower joint front connecting portion | 70: rear lower member |
| 72: rear lower member body | 74: rear lower member flange |
| 90: front side outer member | 100: dash panel |

The drawings referenced above are not necessarily drawn to scale and should be understood as presenting a rather simplified representation of various preferred features illustrating the basic principles of embodiments of the invention. The specific design features of embodiments of the invention, including, for example, specific dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that those skilled in the art can easily implement the technical ideas of the present invention.

As those skilled in the art would realize, the described embodiments may be modified in various different ways, all without departing from the spirit or scope of the present invention.

The terminology used in this specification is for the purpose of describing specific exemplary embodiments and is not intended to limit the embodiments of the present invention. As used herein, singular forms are intended to also include plural forms, unless the context clearly indicates otherwise.

The terms ‘comprising’ and/or ‘including’ as used in this specification indicate the presence of specified features, integers, steps, operations, elements, and/or components, but at least one other feature, integer, step, operation, element, and/or component may be present. It should also be understood that this does not exclude the presence or addition of steps, operations, components, and/or groups thereof.

As used in this specification, the term ‘and/or’ includes any one or all combinations of at least one associated listed item.

In this specification, the term ‘coupled’ or ‘connected’ means that components are directly connected to each other by welding, self piercing rivet (SPR), flow drill screw (FDS), structural adhesive, etc. or indirectly connected through at least one intermediary component, such that there is a physical relationship between two components.

The terms ‘vehicle,’ ‘of a vehicle,’ or other similar terms used in this specification are generally used to refer to passenger automobiles, including passenger vehicles, sport utility vehicles (SUVs), buses, trucks, and various commercial vehicles, and also including hybrid vehicles, electric vehicles, hybrid electric vehicles, hydrogen powered vehicles, and other alternative fuel vehicles (e.g., fuels derived from resources other than petroleum).

In this specification, the ‘front-to-back direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

Furthermore, in this specification, ‘upper end,’ ‘upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

Embodiments will hereinafter be described in detail with reference to the accompanying drawings.

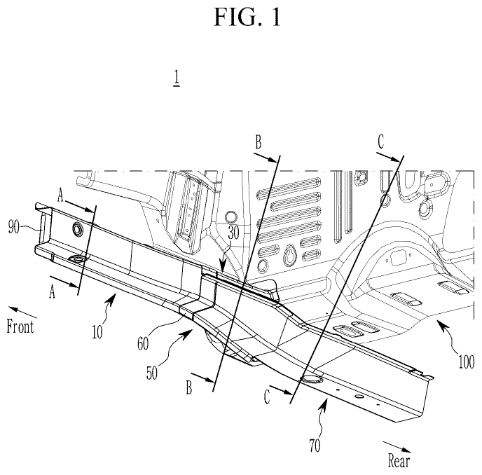

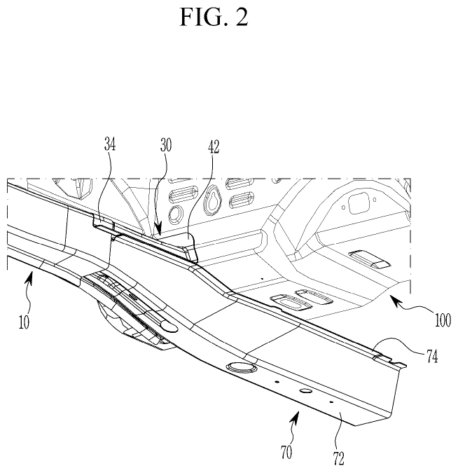

FIG. 1 is a perspective view from the bottom of a front lower structure of a vehicle body according to an embodiment, and FIG. 2 is a drawing with a lower joint member excluded in FIG. 1.

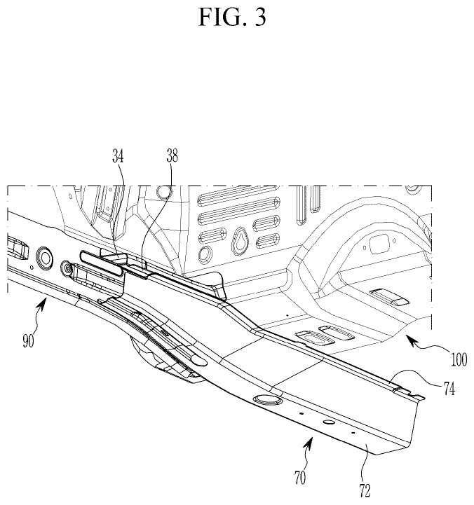

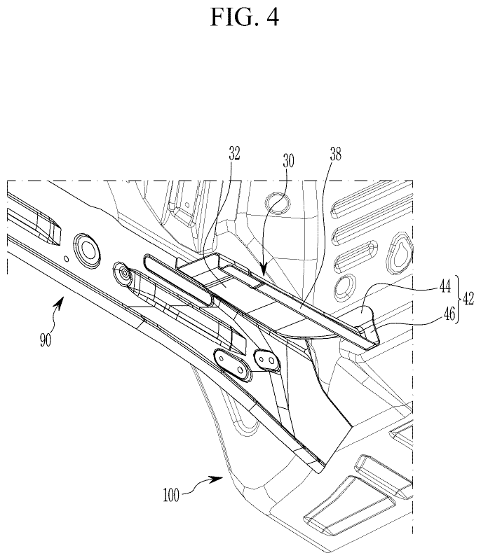

FIG. 3 is a drawing with a front side inner member excluded in FIG. 2, and FIG. 4 is a drawing with a rear lower member excluded in FIG. 3.

Referring to FIG. 1 to FIG. 4, a front lower structure 1 of a vehicle body according to an embodiment may include a front side inner member 10 disposed along the front-to-back direction of the vehicle body on the front lower part of the vehicle body, an upper joint member 30 connected to a rear upper part of the front side inner member 10 and disposed along the front-to-back direction of the vehicle body, and a lower joint member 50 connected to a rear lower part of the front side inner member 10 and a lower part of the upper joint member 30 and disposed along the front-to-back direction of the vehicle body.

The front lower structure according to an embodiment may further include a rear lower member 70 connected to the upper joint member 30 and the lower joint member 50 and mounted on the rear of the upper joint member 30 and the lower joint member 50.

The front lower structure 1 according to an embodiment may further include a front side outer member 90 connected to the front side inner member 10, the upper joint member 30, the lower joint member 50, and the rear lower member 70, and mounted in an outside direction of the vehicle body.

The front side inner member 10, the upper joint member 30, the lower joint member 50, and the front side outer member 90 are connected to form a front side member.

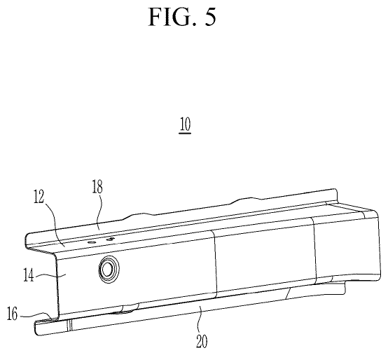

FIG. 5 is a perspective view of the front side inner member of the front lower structure of a vehicle body according to an embodiment.

Referring to FIG. 5, the front side inner member includes a front side upper surface 12, a front side inner surface 14 curved from the front side upper surface 12, a front side lower surface 16 curved from the front side inner surface 14, and a front side upper flange 18 and a front side lower flange 20 that are respectively curved from the front side upper surface 12 and the front side lower surface 16 and connected to the front side outer member 90.

In other words, the front side inner member 10 has an approximately ‘U’-shaped cross-section shape in which changes in the cross-section shape in the length direction are suppressed, so it can be applied as a common part of multiple vehicle types and lowers the manufacturing cost.

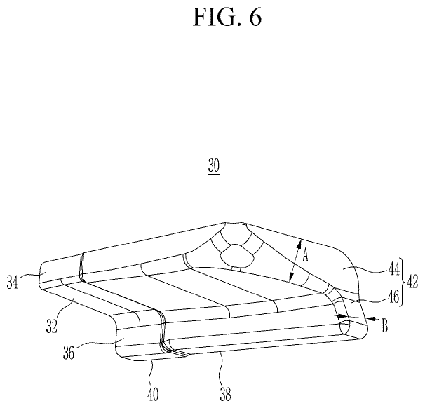

FIG. 6 is a perspective view of an upper joint member of the front lower structure of a vehicle body according to an embodiment.

Referring to FIG. 5 and FIG. 6, the upper joint member 30 includes an upper joint upper surface 32 connected to the front side upper surface 12, an upper joint upper flange 34 curved from the upper joint upper surface 32, an upper joint inner surface 36 connected to at least a portion of the front side inner surface 14, and an upper joint inner flange 38 curved from the upper joint inner surface 36.

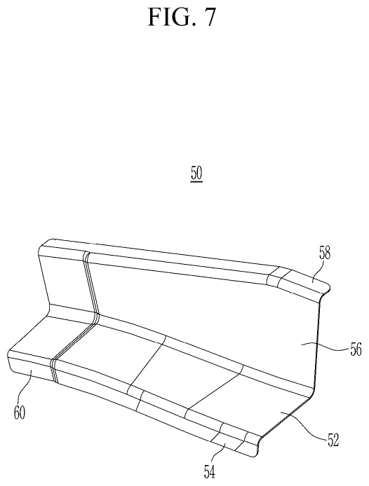

FIG. 7 is a perspective view of the lower joint member of the front lower structure of a vehicle body according to an embodiment.

Referring to FIG. 5 to FIG. 7, the lower joint member 50 includes a lower joint lower surface 52 connected to the front side lower surface 16, a lower joint lower flange 54 curved from the lower joint lower surface 52, a lower joint inner surface 56 connected to at least a portion of the front side inner surface 14, and a lower joint inner flange 58 curved from the lower joint inner surface 56.

The lower joint inner flange 58 may be combined with the upper joint inner flange 38.

The upper joint member 30 and the lower joint member 50 may further include an upper joint front connecting portion 40 and a lower joint front connecting portion 60 connected to the rear of the front side inner member 10, respectively.

For example, the upper joint front connecting portion 40 and the lower joint front connecting portion 60 have a stepped shape, which prevents the front side inner member 10 from being pushed toward the rear direction of the vehicle body during front collision of the vehicle.

In general, the front side member is a very important member that responds to vehicle collision, and collision performance is determined by material or thickness.

Also, the cross-section size of the front side member changes depending on its installation position, connectivity with other members, etc., and it is also necessary to form flanges in various directions.

Therefore, the front side member is a part with relatively high molding difficulty.

And, to improve collision performance due to material selection and thickness limitations, it is necessary to add reinforcing members inside.

Referring to FIG. 1 to FIG. 7, in the front lower structure of a vehicle body according to an embodiment, the front side inner member 10 has a very simplified shape compared to a typical front side member, making it easy to improve collision performance by adjusting the material and thickness.

The upper joint member 30 and the lower joint member 50 are connected to each other and connected to the rear of the front side inner member 10.

In other words, the front side inner member 10 may simplify the manufacturing process with its simple shape and may also be expected to improve collision performance.

The upper joint member 30 and the lower joint member 50 are parts whose shape changes relatively significantly and can distribute the load from the front of the vehicle body to the rear of the vehicle body.

The general front side member has responded to collision by increasing the thickness of the rear part.

For example, when applying a tailor welded blank (TWB) line for proper distribution of collision load, processing becomes complicated and manufacturing costs increase.

However, according to an embodiment of the front lower structure of a vehicle body, the shape is greatly simplified compared to a typical side member, making it possible to improve collision performance by adjusting the material and thickness.

In addition, by adjusting the length of the lower joint member 50 along the front and rear direction of the vehicle body, the amount of deformation during vehicle collision can be increased to reduce the RTE and suppress injuries to occupants.

Additionally, by adjusting the length of the lower joint member 50 along the height direction of the vehicle body for controlling the amount of deformation (dipping amount) in the height direction of the vehicle during collision, injuries to occupants can be suppressed.

The front lower structure according to an embodiment may further include a dash panel 100 connected to the rear of the upper joint member 30, an upper portion of the rear lower member 70, and a rear of the front side outer member 90.

The upper joint member 30 may include an upper joint rear flange 42 curved to be connected to the dash panel 100.

The upper joint rear flange 42 includes an upper joint rear upper flange 44 curved from the upper joint upper surface 32 formed at the upper portion thereof and an upper joint rear inner flange 46 curved from the upper joint inner surface 36 formed on an inner side thereof.

The general front side member is mounted on the front of the dash panel and the bottom of the floor, has a relatively complex shape for connection to other parts, and is expensive to process.

In other words, notches may be formed after manufacturing due to the difficulty of forming the side member, and restrictions on flange size occur.

Accordingly, when a vehicle collides, the front side member may penetrate the dash panel and cause injury to occupants in the cabin.

However, in the front lower structure 1 according to an embodiment, the front side inner member 10, the upper joint member 30, and the lower joint member 50 are manufactured separately and the relatively simplified parts are assembled to form the front side member.

In addition, the upper joint rear upper flange 44 and the upper joint rear inner flange 46 of the upper joint rear flange 42, which are connected to the dash panel 100, have relatively small size restrictions to properly distribute the impact load during vehicle collision, and thus damage to the dash panel 100 can be prevented.

In other words, the upper joint member 30, which is manufactured separately, can suppress the occurrence of notches due to its high material selection and design degree of freedom.

A floor panel (not shown) is mounted on the rear of the dash panel 100, and the upper part of the floor panel is defined as the cabin space.

This combination relationship is obvious to those skilled in the art, so a detailed description will be omitted.

In FIG. 6, by lengthening the length A of the upper joint rear upper flange 44, the ratio of collision energy being transmitted to the dash panel 100 can be increased.

Additionally, by increasing the length B of the upper joint rear inner flange 46, fracture can be prevented by strengthening the connectivity of the matching surface in the front direction of the dash panel 100.

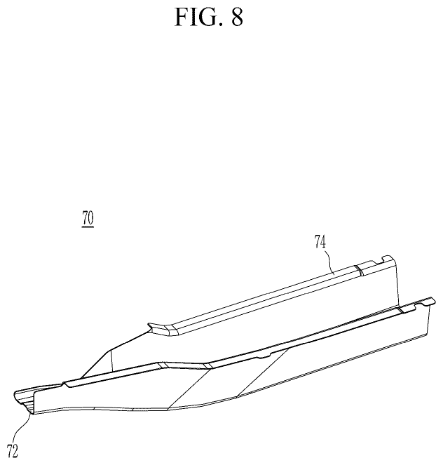

FIG. 8 is a perspective view of the rear lower member of the front lower structure of a vehicle body according to an embodiment.

Referring to FIG. 1 to FIG. 8, the rear lower member 70 may include a rear lower member body 72 of a “U”-shaped cross-section shape and a rear lower member flange 74 that is curved from the rear lower member body 72 and connected to the dash panel 100.

A front of the rear lower member 70 may be connected to the rear of the front side inner member 10.

The front side inner member 10 is connected not only to the upper joint member 30 and the lower joint member 50, but also to the rear lower member 70, so that the connectivity of the front lower structure 1 can be strengthened.

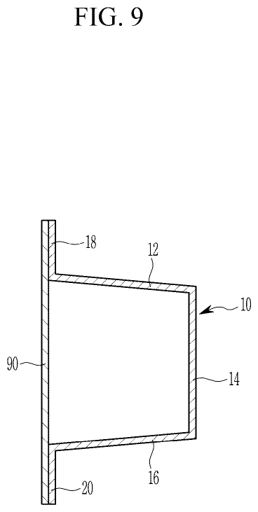

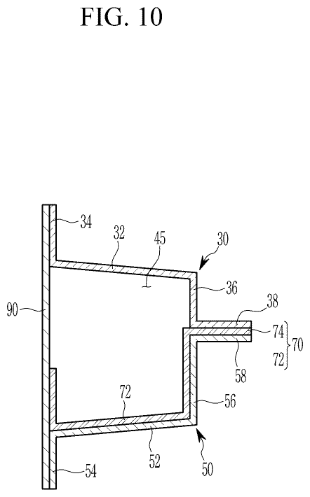

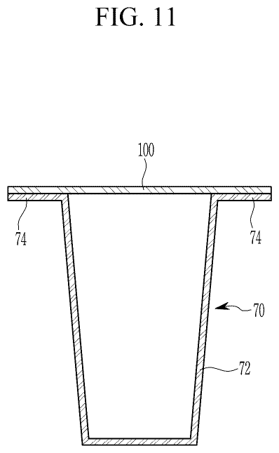

FIG. 9 is a cross-sectional view along line A-A in FIG. 1, FIG. 10 is a cross-sectional view along line B-B in FIG. 1, and FIG. 11 is a cross-sectional view along line C-C in FIG. 1.

As shown in FIG. 9, the front side outer member 90 and the front side inner member 10, which has an approximately ‘U’ shaped cross-section shape, form the front side member by their combination.

Additionally, the front side outer member 90 and the front side inner member 10 may form a closed cross-section along the front-to-back direction of the vehicle body to increase the front-to-back direction strength of the vehicle body.

Referring to FIG. 10, the upper joint member 30 and the lower joint member 50 are connected to form a joint space 45 on the inside, and a part of the rear lower member 70 may be connected to the inside of the joint space 45.

In other words, the rear lower member body 72 of the rear lower member 70 may be coupled to the lower joint lower surface 52 of the lower joint member 50.

The lower joint member 50 may include the lower joint inner flange 58 connected to the dash panel 100 through the rear lower member flange 74.

The rear lower member flange 74 may be inserted and combined between the lower joint inner flange 58 and the upper joint inner flange 38, and the three flanges may be connected to increase joint strength and facilitate impact load distribution.

Additionally, the rear lower member flange 74 is connected to the dash panel 100, so that the connectivity of the upper joint member 30, the lower joint member 50, and the dash panel 100 can be strengthened.

As shown in FIG. 11, the rear lower member body 72 of the rear lower member 70 has an approximately ‘U’ shape and is connected to the dash panel 100 through the rear lower member flange 74.

Additionally, the rear lower member 70 and the dash panel 100 form a closed space, which can increase the cross-section coefficient.

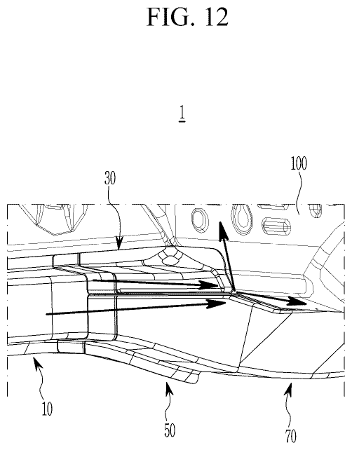

FIG. 12 is a drawing showing load transfer paths of the front lower structure of a vehicle body according to an embodiment.

Referring to FIG. 12, in the front lower structure 1 according to an embodiment, when the vehicle is struck, the collision energy may be stably distributed to the dash panel 100 and the floor of the vehicle body through the front side inner member 10, the upper joint member 30, the lower joint member 50, and the rear lower member 70.

In addition, according to the front lower structure 1 according to an embodiment, the RDE of the portion where the upper joint member 30, the lower joint member 50, the rear lower member 70, and the dash panel 100 are connected increases, and through this, it is possible to reduce the RTE.

In addition, according to the front lower structure 1 according to an embodiment, the connection between the side member and the dash panel 100 along the front and rear directions of the vehicle body is strengthened, and the connection between the side member and the rear lower member 70 can be strengthened.

In addition, according to the front lower structure 1 according to an embodiment, the region occupied by the rear lower member 70, which is a relatively strong member, is increased, and the cross-section of the side member and the cross-section of the rear lower member 70 may be connected smoothly.

Additionally, according to the front lower structure 1 according to an embodiment, structural efficiency can be increased by relatively reducing the cutting region.

Additionally, according to an embodiment of the front lower structure 1, the collision performance of the side member is improved, thereby reducing the need for an additional reinforcing member therein.

In addition, according to the front lower structure 1 according to an embodiment, the connection between the side member and the dash surface is strengthened, the connection between the side member and the rear lower member is strengthened, and the flange is connected in three directions to prevent separation.

While embodiments of this invention have been described in connection with what is presently considered to be practical embodiments, it is to be understood that the embodiments of the invention are not limited to the disclosed embodiments. On the contrary, they are intended to cover various modifications and equivalent arrangements included within the spirit and scope of the appended claims.

What is claimed is:

1. A front lower structure of a vehicle body, the front lower structure comprising:
a front side inner member disposed along a front-to-back direction of the vehicle body on a front lower part of the vehicle body;
an upper joint member connected to a rear upper part of the front side inner member and disposed along the front-to-back direction of the vehicle body; and
a lower joint member connected to a rear lower part of the front side inner member and a lower part of the upper joint member and disposed along the front-to-back direction of the vehicle body.

2. The front lower structure of claim 1, further comprising a rear lower member connected to the upper joint member and the lower joint member and mounted on rear parts of the upper joint member and the lower joint member.

3. The front lower structure of claim 2, further comprising a front side outer member connected to the front side inner member, the upper joint member, the lower joint member, and the rear lower member, and mounted in an outside direction of the vehicle body.

4. The front lower structure of claim 3, wherein the front side inner member comprises:
a front side upper surface;
a front side inner surface curved from the front side upper surface;
a front side lower surface curved from the front side inner surface; and
a front side upper flange and a front side lower flange that are respectively curved from the front side upper surface and the front side lower surface and connected to the front side outer member.

5. The front lower structure of claim 4, wherein the upper joint member comprises:
an upper joint upper surface connected to the front side upper surface;
an upper joint upper flange curved from the upper joint upper surface;
an upper joint inner surface connected to the front side inner surface; and
an upper joint inner flange curved from the upper joint inner surface.

6. The front lower structure of claim 5, wherein the lower joint member comprises:
a lower joint lower surface connected to the front side lower surface;
a lower joint lower flange curved from the lower joint lower surface;
a lower joint inner surface connected to the front side inner surface; and
a lower joint inner flange curved from the lower joint inner surface.

7. The front lower structure of claim 6, wherein the upper joint member and the lower joint member further comprise an upper joint front connecting portion and a lower joint front connecting portion connected to the rear upper part and the rear lower part of the front side inner member, respectively.

8. The front lower structure of claim 2, wherein a front of the rear lower member is connected to the rear lower part of the front side inner member.

9. The front lower structure of claim 8, wherein:
the upper joint member and the lower joint member are connected to form a joint space on an inside; and
a part of the rear lower member is connected to an inside of the joint space.

10. A front lower structure of a vehicle body, the front lower structure comprising:
a front side inner member disposed along a front-to-back direction of the vehicle body on a front lower part of the vehicle body;
an upper joint member connected to a rear upper part of the front side inner member and disposed along the front-to-back direction of the vehicle body;
a lower joint member connected to a rear lower part of the front side inner member and a lower part of the upper joint member and disposed along the front-to-back direction of the vehicle body;
a rear lower member connected to the upper joint member and the lower joint member and mounted on rear parts of the upper joint member and the lower joint member;
a front side outer member connected to the front side inner member, the upper joint member, the lower joint member, and the rear lower member, and mounted in an outside direction of the vehicle body; and
a dash panel connected to the rear part of the upper joint member, an upper portion of the rear lower member, and a rear of the front side outer member.

11. The front lower structure of claim 10, wherein the upper joint member comprises an upper joint rear flange curved to connect to the dash panel.

12. The front lower structure of claim 11, wherein the upper joint rear flange comprises:
an upper joint rear upper flange curved from an upper joint upper surface disposed at an upper side thereof; and
an upper joint rear inner flange curved from an upper joint inner surface disposed on inner side thereof.

13. The front lower structure of claim 10, wherein the rear lower member comprises:
a rear lower member body of a “U” shaped cross-section shape; and
a rear lower member flange that is curved from the rear lower member body and connected to the dash panel.

14. The front lower structure of claim 13, wherein the lower joint member comprises a lower joint inner flange connected to the dash panel through the rear lower member flange.

15. A vehicle body comprising:
a dash panel;
a floor panel disposed at a rear of the dash panel, wherein an upper surface of the floor panel defines a cabin space of the vehicle body;
a front side inner member disposed along a front-to-back direction of the vehicle body on a front lower part of the vehicle body;
an upper joint member connected to a rear upper part of the front side inner member and disposed along the front-to-back direction of the vehicle body; and
a lower joint member connected to a rear lower part of the front side inner member and a lower part of the upper joint member and disposed along the front-to-back direction of the vehicle body.

16. The vehicle body of claim 15, further comprising:
a rear lower member connected to the upper joint member and the lower joint member and mounted on rear parts of the upper joint member and the lower joint member; and
a front side outer member connected to the front side inner member, the upper joint member, the lower joint member, and the rear lower member, and mounted in an outside direction of the vehicle body, wherein the dash panel is connected to the rear part of the upper joint member, an upper portion of the rear lower member, and a rear of the front side outer member.

17. The vehicle body of claim 16, wherein:
a front of the rear lower member is connected to the rear lower part of the front side inner member;
the upper joint member and the lower joint member are connected to form a joint space on an inside; and
a part of the rear lower member is connected to an inside of the joint space.

18. The vehicle body according to claim 16, wherein the front side inner member comprises:
a front side upper surface;
a front side inner surface curved from the front side upper surface;
a front side lower surface curved from the front side inner surface; and
a front side upper flange and a front side lower flange that are respectively curved from the front side upper surface and the front side lower surface and connected to the front side outer member.

19. The vehicle body of claim 18, wherein the upper joint member comprises:
an upper joint upper surface connected to the front side upper surface;
an upper joint upper flange curved from the upper joint upper surface;
an upper joint inner surface connected to the front side inner surface; and
an upper joint inner flange curved from the upper joint inner surface.

20. The vehicle body of claim 18, wherein the lower joint member comprises:
a lower joint lower surface connected to the front side lower surface;
a lower joint lower flange curved from the lower joint lower surface;
a lower joint inner surface connected to the front side inner surface; and
a lower joint inner flange curved from the lower joint inner surface.
